(19) United States
(12) Patent Application Publication
(10) Pub. No.: US 2013/0235255 A1
(43) Pub. Date: Sep. 12, 2013

(54) OPTICAL IMAGING SYSTEM FOR MULTISPECTRAL IMAGING

(71) Applicants: Peter Westphal, Jena (DE); Gerhard Krampert, Jena (DE)

(72) Inventors: Peter Westphal, Jena (DE); Gerhard Krampert, Jena (DE)

(73) Assignee: CARL ZEISS AG, Oberkochen (DE)

(21) Appl. No.: 13/824,306

(22) PCT Filed: Aug. 31, 2011
(86) PCT No.: PCT/EP2011/064955

§ 371 Date: May 31, 2013

(30) Foreign Application Priority Data
Sep. 17, 2010 (DE) 10 2010 045 856.2

(51) Int. Cl. G01N 21/25

(52) U.S. Cl. CPC G01N 21/25
USPC 348/360

(57) ABSTRACT

An optical imaging system for multispectral imaging. A filter arrangement for selecting particular spectral ranges is located in a beam path coming from an object to be imaged, and at least one detection device is provided for receiving the selected spectral ranges. The imaging system comprises optical assemblies for generating an imaging beam path of polychromatic light coming from the object to be imaged, a filter arrangement for sequentially or simultaneously selecting particular spectral ranges provided for imaging the object from the imaging beam path, at least one detection device for the light of the selected spectral ranges, and an image display and/or image analysis device connected to the detection device, wherein the filter arrangement comprises a plurality of individual filter areas disposed adjacent to each other and lateral to the extension direction of the imaging beam path, said areas being designed for selecting different spectral ranges, and a deflecting device for aligning the imaging beam path to individual filter areas.

### RELATED APPLICATIONS

The present application is a National Phase entry of PCT Application No. PCT/EP2011/064955, filed Aug. 31, 2011, which claims priority from DE Application No. 10 2010 045 856.2, filed Sep. 17, 2010, which applications are hereby incorporated by reference herein in their entirety.

### FIELD OF THE INVENTION

The present invention relates to an optical imaging system for multispectral imaging, and more specifically to a filter arrangement for selecting certain spectral ranges positioned in a beam path coming from an object to be imaged, and at least one detection device for receiving the selected spectral ranges.

The present invention is to be assigned to the technical fields of imaging arrangements, which either allow a certain spectral resolution using a digital camera with a position-sensing image sensor, for example, or which also scan an object to image it on a single detector with predetermined spectral resolution. In general, the invention may also be referred to as an imaging multispectral measurement arrangement or as a multispectral camera.

### BACKGROUND OF THE INVENTION

For selection, i.e., filtering of certain spectral ranges, filter wheels have traditionally been positioned in the beam path, typically with approximately three to ten separate individual spectral filters arranged on the wheels.

Unfortunately, with such filter wheels, the switching time between two filters having different spectral properties is in the range 50 ms to 500 ms, which is thus too high for a rapid spectral image recording. The reason for this is that the relatively great mass, i.e., weight of the filters, frames and filter wheel cannot be accelerated indefinitely at a reasonable expense. Furthermore, the number of spectral channels is greatly limited due to the space required for filter wheels.

However, filter wheel arrangements in which the filter wheel is moved at a constant rotational speed are also known. However, such arrangements are suitable only for fixed image frequencies and the same exposure times for all color channels, for example, for projectors.

In addition, an ARRANGEMENT FOR GENERATING SPECTRALLY RESOLVED IMAGE SEQUENCES in which a strip-shaped filter mask is passed in front of a 2D camera chip is also known, as described in greater detail in DE 102006018315 A1. While photographing an object, the filter mask is moved by means of a linear motor in relation to the camera chip, so that each color strip of the mask is positioned once in front of an area of the camera chip that is also in the form of strips. The result is colored strips of individual photographs, from which a set of spectral full-frame images is calculated.

The disadvantages of this arrangement consist mainly of the fact that the filter mask positioned directly in front of the camera chip leads to cross talk between colors situated next to one another and the required linear guide including the motor drive is relatively large and has a high mass so that vibrations occur at high accelerations. Furthermore, all the color channels are necessarily exposed for equal lengths of time.

US 020080123097 A2 describes a SYSTEM FOR MULTI- AND HYPERSPECTRAL IMAGING, in which a mosaic type arrangement of broadband overlapping color filters is used. A spectrally resolved image comprised of multiple individual photographs is reconstructed here, these photographs overlapping one another spectrally, so that different color filters, usually band-pass filters, partially transmit or reflect the same wavelengths.

In addition, there are known multispectral imaging devices whose function is based on moving a dispersive element, for example, a grid or prism or a liquid crystal tunable filter (LCTF) and/or an acousto-optic tunable filter (AOTF). This method usually has the disadvantage of a low light efficiency.

### SUMMARY OF THE INVENTION

Against this background, the object of the present invention is to create an optical imaging system of the type defined in the introduction, in which a plurality of spectral channels can be made available in the imaging beam path in a much shorter amount of time than is possible in the state of the art and which can also be manufactured inexpensively.

According to the invention, such an imaging system comprises:
optical modules for creating an imaging beam path from the polychromatic light coming from the object to be imaged,
a filter arrangement for sequential or simultaneous selection of certain spectral ranges, which are provided for imaging the object, from the imaging beam path,
at least one detection device for the light of the selected spectral ranges, and
an image display and/or image analysis device which is connected to the detection device, such that
the filter arrangement has several individual filter areas, which are designed for selecting different spectral ranges and are arranged side by side laterally to the propagation direction of the imaging beam path, and
a deflection device, which is provided and through which the imaging beam path is directed at individual filter areas whose properties correspond to the spectral ranges to be selected.

The filter arrangement is preferably designed as a filter mask having individual filter areas that are separated from one another spectrally or run into one another spectrally and are designed in the form of a matrix, a honeycomb or strips, these filter areas having different spectral transmission properties and/or reflection properties.

In a particularly advantageous embodiment of the invention, an electrostatically or galvanically driven scanning mirror, preferably a MEMS scanner, is provided as the deflecting device and is coupled to a control circuit for presetting the deflection angles in which the imaging beam path is always directed at the individual filter areas predetermined for selection of spectral ranges. The deflection may be provided either continuously or discontinuously.

It is also within the scope of the inventive idea to provide several filter masks that can be interchanged with one another in the imaging beam path and which have optical properties that are different with respect to their individual filter areas. This makes it possible to multiply the number of available spectral channels. The filter mask may be accommodated in a filter wheel or a translatory device.

The individual filter areas may be designed to be either transmitting or reflective. In this case, separate detection devices are provided for the transmitted radiation components and the reflected radiation components. The spectral ranges of the individual filter areas may be complementary to one another or may overlap.

The design of the preferred detection device depends on whether the invention is part of a wide field measurement field or a scanning measurement system. In a wide field measurement system, a complete imaging beam path must be detectable simultaneously by the detection device; therefore, in this case a camera-type, position-sensing detector is to be used, for example, a CCD camera or a CMOS camera. Depending on the design variant of the invention, the entire chip area of the camera may be used simultaneously or a separate subarea of the camera may be used for each color channel.

In the case of scanning measurement system, a single detector, for example, a photomultiplier or a photodiode may be used instead of the camera and/or instead of a subarea of the camera, because in this case the imaging is performed sequentially rather than simultaneously. In the case of a line scanner, however, a detection device which has spatial resolution in at least one direction in space is to be used, i.e., a line scan camera, for example.

In additional advantageous embodiments of the invention, a facetted mirror, a diffractive optical element (DOE) or a second deflecting device may be arranged downstream from the filter arrangement and/or the filter mask to thereby achieve compensation of the change in direction of the imaging beam path caused by the first deflection device, so that all the spectral ranges selected are directed at a single sensor, regardless of this change in direction.

In summary, the idea according to the present invention consists of, among other things, deflecting or shifting the entire imaging beam path with the help of a mirror, which is driven by an actuator, so that it can be directed optionally at different individually filter areas of the spectrally selective filter mask, so that the individual filter areas have different band-pass filter properties or cut-off filter properties. Multiband filters and/or combinations of multiband filters and cut-off filters are also conceivable.

Essentially a small scanning mirror, preferably a MEMS mirror which can be moved much more rapidly than a collection of spectral filters situated in a filter wheel, for example, because of its low mass is used. Therefore, it is possible to switch from one active spectral channel to another in less than 10 ms, which is thus much faster than when using a filter wheel.

One important advantage of the invention consists of these spectral resolutions of more than three spectral channels, such as those which were customary with color cameras in the past. The number of spectral channels with the imaging system according to the present invention may be in the range of 4 to 200; however, a lower and/or optimal number of 4 to 36 spectral channels may also be provided in view of the technical effort.

Another advantage is that a group of spectral channels can be selected as needed from the filter mask, so that the exposure times for the selected spectral channels may be different and may deviate by a factor of >10. This is important in fluorescence microscopy, for example, where the required exposure time for different fluorescent colors may vary greatly. With the help of the scanner, the imaging beam path can be deflected to the different areas of the filter mask for an optimized period of time in each case. Thus, a first area may represent a band-pass filter, for example, which optimally transmits the fluorescent radiation of the dye Cy3, while another area represents a band-pass filter, which optimally transmits the fluorescent radiation of the dye Cy5.

The spectrally selective modules of the imaging system according to the present invention, i.e., essentially the scanner and the filter mask, advantageously have a high transmission efficiency of >70%, so that there is also suitability for imaging measurements of reflections, scattered light, absorption and luminescence, including fluorescence in particular.

The imaging system according to the present invention can be used to particular advantage in microscopy, but it can also be used in the form of a general multispectral camera. The physical implementation may be in a design which permits use as a replacement instead of a standard camera. In principle, it is possible to use this for both wide-field imaging, scanning imaging by means of point scanners and line scanners but also for the spinning disk method, which combines the advantages of high resolution confocal microscopy with those of wide-field microscopy in a complete system.

This yields applications in conjunction with the separation of multiple spectrally overlapping fluorescence spectra, for example, in Q-dots or organic dyes, multicolor FISH, FRET imaging, autofluorescence suppression, analysis of spectral changes, for example, changes in pH- or ion-sensitive dyes, spectral karyotype analysis with respect to chromosome properties, bright-field histopathology, characterization of nanoparticles, component analysis in material microscopy, dermatology, in particular in predicting skin cancer, for separation of plastics in the recycling industry, process control in the pharmaceutical industry, the textile industry and other industries, food analysis, forensic medicine, from agriculture to satellite monitoring of useful areas, landscape mapping and geology, for example, for drill core analyses.

It is self-evident that the features mentioned above and those yet to be discussed below may be used not only like any others but may also be used in other configurations without going beyond the scope of the idea according to the present invention.

### BRIEF DESCRIPTION OF THE DRAWINGS

The present invention is explained in greater detail below on the basis of exemplary embodiments depicted in respective drawings in which:

FIG. 1 shows a basic embodiment of the optical imaging system according to the present invention;

FIG. 2 shows a first design variant, in which an imaging lens and a stationary deflecting mirror are situated between the filter mask and the location of the final image;

FIG. 3 shows a second design variant, in which the imaging beam path is directed at a DOE after passing through the filter mask;

FIG. 4 shows a third design variant, in which the imaging beam path is directed at a facetted mirror after passing through the filter mask;

FIG. 5 shows a fourth design variant, in which the imaging beam path is directed at a second scanning mirror after passing through the filter mask;

FIG. 6 shows a fifth design variant, in which the use of the radiation transmitted on the filter mask as well as the reflected radiation is provided; and

FIG. 7 shows another advantageous design variant of the invention, in which a graduated spectral filter is positioned in an optical pupil of the imaging beam path.

### DETAILED DESCRIPTION

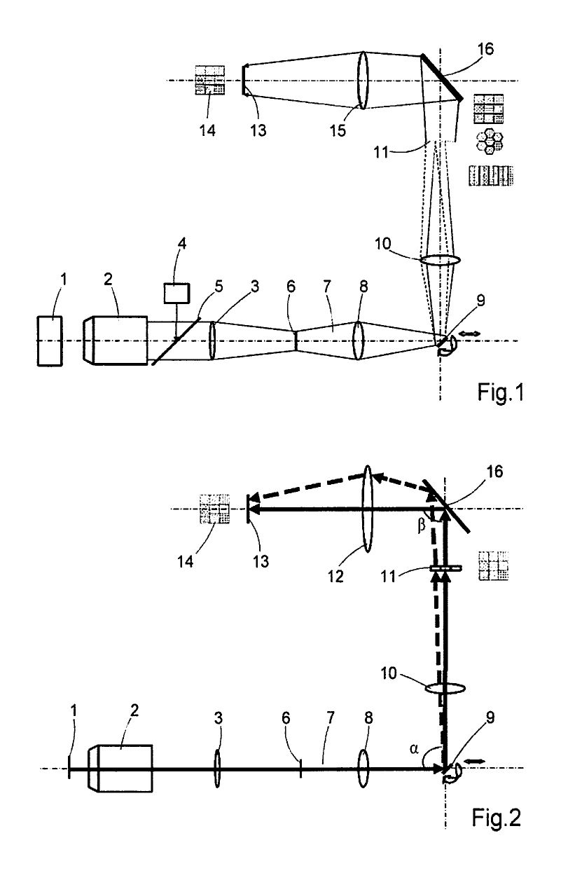

FIG. 1 shows as an example the basic design of the imaging system according to the present invention, which is designed to generate spectrally resolved images of an object 1. This imaging system has an object lens 2 and a tubular lens 3, which are preferably modules of a microscope but may also be parts of another imaging device such as, for example, an operational microscope, a fundus camera or a measurement camera.

The object lens 2 may in principle be part of any imaging optical microscope configuration. In particular it may also be a SPIM arrangement (SPIM=selective plane illumination microscope), an LSM (laser scanning microscope) or a spinning disk microscope.

The area of use extends to both biological and medical applications as well as to materials testing and semiconductor inspection.

A light source 4 is provided to illuminate the object 1. The light emanating from the light source 4 is directed at the reflective surface of a dichroic beam splitter 5 and from there through the object lens 2 onto the object 1. The light reflected or scattered by the object 1 again passes through the object lens 2 and the beam splitter 5 and enters the tubular lens 3.

In the diagram according to FIG. 1, object illumination with polychromatic light in the visible spectral range is provided. However, a fluorescence excitation is also conceivable. In this case, the exciting radiation emanating from the light source 4 should be restricted in a spectrally sharp-edged manner by the exciting radiation emanating from the light source 4 through sharp-edged spectral filters or by laser radiation (not shown in the drawing). The beam splitter is then designed so that it reflects the exciting radiation and the fluorescence emission is transmitted.

In an imaging device according to the state of the art, a camera would be provided in the intermediate image 6 to record digital images. If color images are to be recorded, a color camera with a Bayer color mask should usually be provided.

Instead of that, the imaging beam path 7 is continued after the intermediate image 6 according to the invention and the imaging beam path 7 is bundled and deflected onto a scanning mirror 9 through an optical system 8.

The beam diameter at the location of the scanning mirror 9 should be as small as possible so that a scanning mirror 9 which has a smaller size and a low weight may be utilized, this mirror being adjustable by means of electrostatic or galvanic drives, preferably a MEMS mirror (MEMS=microelectromechanical systems). For larger mirrors, e.g., with a mirror area greater than a diameter of approximately 10 mm, a conventional galvanically adjustable mirror may be provided.

It is within the scope of the present invention to create another intermediate image or a pupil of the imaging beam path 7 at the location of the scanning mirror 9. If there is an intermediate image here, the scanning mirror 9 is preferably covered with dust protection glass panes, which are a distance of at least 1 mm from the mirror surface. This prevents dust particles from appearing sharply imaged in the final image 13.

The first scanning mirror 9 can be tilted about an axis, but preferably by two orthogonal axes, so that in the latter case the imaging beam path 7 can be deflected about both axes. In each case, the stipulation of the angle of deflection that is to be achieved by the scanning mirror 9 is possible by electronic control.

Instead of or in addition to a rotational movement and/or a tilting movement, the scanning mirror 9 may also be arranged to permit a translatory movement to enable the imaging beam path 7 to be shifted to the filter mask 11, which is described in great detail below, and/or the final image 13. The translatory movement may be implemented via linear motors, for example. For reasons of simplicity, no motor drives for the scanning mirror 9 are depicted in FIG. 1, but the translatory movement directions are indicated only by arrows. In addition, the rotational and tilting directions of the scanning mirror 9 are not limited, i.e., both clockwise and counterclockwise directions are possible and the tilt axes may be arranged in any desired manner in space. Similarly, this is also true of its translatory movement.

By means of an additional optical system 10, the imaging beam path 7 is directed at a two-dimensional filter mask 11. To be sure, each spectral filter per se is already two-dimensional, but the term “two-dimensional” in the sense of the present invention means explicitly that the filter mask 11 has spectral variations over its lateral extent.

These spectral variations should preferably be discontinuous. If the imaging system according to the present invention is designed so that the scanning mirror 9 is located in or near an intermediate image, then the filter mask 11 will be positioned in or near a pupil plane. However, if the mirror 9 is in or near a pupil plane, then the filter mask 11 is positioned in or near an intermediate image. This ensures that changes in the deflection angle for the imaging beam path 7 through the scanning mirror 9 will lead to a lateral shift in the imaging beam path 7 on the filter mask 11.

The scanning mirror 9 thus has the task of deflecting the complete imaging beam path 7 onto a single filter area of the filter mask 11 to induce spectral filtering there. The individual filter areas consist of individual laterally homogeneous transmission filters. These may be both spectral band-pass filters and spectral cut-off filters. In addition, the use of spectral multiband filters and/or a combination of multiband filters and cut-off filters is also conceivable. The various individual filter areas may be spectrally complementary to one another or may overlap with one another. The covered spectral range for the transmission filters may extend from 200 nm to 2000 nm. However, the main use may be in the range of 300 nm to 1000 nm.

The individual filter areas may be arranged laterally in various ways, e.g., in the form of a matrix, a honeycomb or strips as indicated in FIG. 1, while being spectrally separate with different spectral transmission properties which are symbolized by differences in hatching in the drawings.

Matrix-type arrangements are technologically simple to produce. A honeycomb arrangement minimizes the filter area because a hexagonal single filter area is usually better adapted to the round cross section of the beam than a square cross section. Strip-shaped single filter areas in turn minimize the scanning angle when changing from one single filter area to another when only one scanning direction is being used. However, anamorphotic optical elements are to be used with the latter because the beam cross section must have a strongly asymmetrical shape for the strip-shaped single filter areas. This asymmetrical shaping of the final image 13 must be reversed by additional anamorphotic optical elements.

Since the imaging beam path 7 has passed through the filter mask 11, after being reflected on a stationary deflecting mirror 16 which is introduced into the imaging beam path 7 for the purpose of reducing the design volume, the final image 13 is created with an additional optical system 15 and this image then has spectral filtering. The image 13 is recorded by a position-sensing detector 14, which has a receiving surface with a lateral extent here, for example. The detector 14 is part of a digital camera, for example, but may also be coupled to an image playback device and/or an image analysis device as a separate module. Its receiving surface is represented symbolically in a side view at the left next to the location where the image 13 is formed.

Several different design variants of the imaging system according to the present invention are described below. For reasons of simplicity, the same reference numerals are used for the same components in FIGS. 2 through 7, which are shown for the purpose of illustration, as in FIG. 1 already.

FIG. 2 shows a first design variant in which only one imaging lens 12 is located between the filter mask 11 and the final image 13 and this in turn is a stationary deflecting mirror 16 for the purpose of reducing the design volume. The imaging lens 12 here is designed so that the individual filter areas of the filter mask 11 are assigned to corresponding subareas on the receiving surface of the detector 14, which is monochromatic in this case, so that at a certain point in time only one subarea of this receiving surface is illuminated. Since the object is completely imaged on each subarea of the receiving surface, it is advantageous to use a large-area camera chip of at least 5 megapixels as the detector 14 to ensure an acceptable pixel resolution.

In addition, FIG. 2 shows symbolically the two deflecting angles α and β created by the scanning mirror 9 between the primary optical axes before and after the respective beam deflection. The deflecting angles α and β here each amount to 90°, but any other angles may also be stipulated as long as the optical components do not hinder one another mutually in space or intersect with the imaging beam path 7.

To achieve a compact design, for example, it is advantageous to provide a value in the range of 20°<α<70° for the deflecting angle α and a value in the range of 290°<β<340° for the deflecting angle β. Then the alignments of the deflecting mirror 16 are to be adapted accordingly. An embodiment in which the deflecting angles α and β do not both lie in the same plane but instead form orthogonal planes to one another, for example, is also possible.

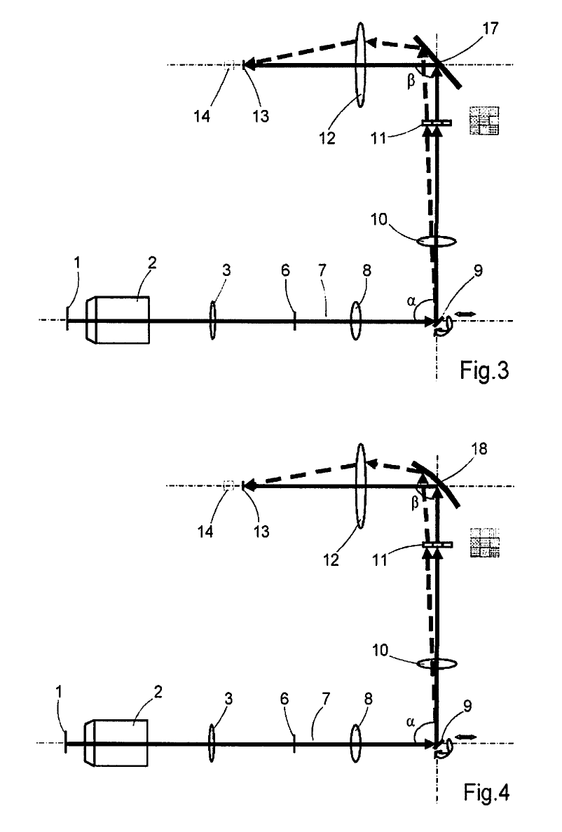

FIG. 3 shows a second design variant in which the imaging beam path 7 strikes a DOE 17 after passing through the filter mask 11. The DOE 17 here has the function of adjusting the deflecting angles α and β created by the scanning mirror 9 as a function of the average wavelength of the respective single filter area of the filter mask 11, which is selected and used so that the final image 13 is always formed in the same location, regardless of the average wavelength. This achieves the result that it is possible to use a smaller camera chip than in the first design variant. To optimally implement this second design variant, additional lenses designed for this purpose in the form of lenses or lens systems may also be inserted into the imaging beam path 7.

FIG. 4 shows a third design variant in which a wavelength independent deflection of the imaging beam path 7 onto the same location of the final image 13 with a facetted mirror 18 is implemented. This makes use of the fact that the imaging beam path 7 has different directions of propagation after passing through the filter mask 11, so that it strikes the different facets of the facetted mirror 18, depending on the individual filter area used. Since each facet causes a different deflecting angle, the final image 13 here is also always formed in the same location, so that again a smaller camera chip may be used than that used in the first design variant.

FIG. 4 shows only a section through the facetted mirror 18. Since the filter mask 11 is designed to be two-dimensional, the facetted mirror 18 is designed so that it also produces deflecting angles which vary at a right angle to the plane of the drawing. To optimally implement this third design variant, other object lenses in the form of individual lenses or lens systems designed for this purpose may also be inserted into the imaging beam path 7 here.

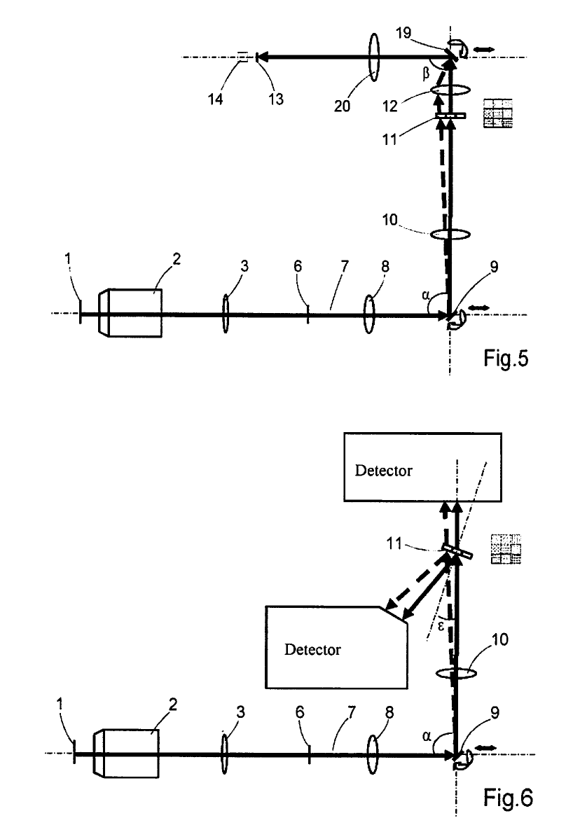

FIG. 5 shows a fourth design variant in which the wavelength-independent deflection of the imaging beam path 7 onto the same location in the final image 13 is performed using a second scanning mirror 19. The second scanning mirror 19 thus compensates for the deflection of the first standing mirror 9. With the design variants according to FIG. 3 and FIG. 4, the advantage is that the final image 13 is always formed in the same location without using any moving elements in addition to the first scanning mirror 9, but the design variant according to FIG. 5 has the advantage that the direction of the imaging beam path 7 after the second scanning mirror 19 is the same at each wavelength despite the use of another moving element in the form of the second scanning mirror 19, so that the light always falls on the detector 14 at the same angle. This is advantageous when using camera chips with microlens arrays because the they have a limited acceptance angle. In addition, an optical system 20 with a comparatively small diameter may then be used, thereby reducing costs and installation space.

The second scanning mirror 19, like the first scanning mirror 9, is usually tiltable by two axes unless the filter mask 11 has spectral variations in only one direction. The second scanning mirror 19 is preferably also a MEMS mirror.

Here again, however, when large mirror diameters are required, a conventional galvanic mirror may also be used. Alternatively or in addition to the rotational movement, the second scanning mirror 19 may also be moved by a translatory movement to achieve an optimal function.

FIG. 6 shows a fifth design variant in which the radiation additionally reflected by the filter mask 11 is utilized. To do so, the filter mask 11 is tilted so that it is no longer perpendicular to the optical axis. This is represented by a dash-dot line in FIG. 5. This surface normal of the filter mask 11 then forms an angle ε with the optical axis of imaging beam path 7. The angle ε may be in the range of 10° to 80°.

One detector each is provided for receiving the transmitted radiation and the reflected radiation, for example.

The essential advantage of the fifth design variant consists of the fact that all the spectral components of the radiation received by lens 2 can be utilized simultaneously. When using dichroic filters, the radiation reflected by the filter mask 11 is spectrally complimentary to the transmitted radiation. By using two imaging detection devices, for example, two spectral channels can be operated simultaneously with full spatial resolution.

Detection may also be performed in a cascade arrangement of downstream detection devices, so that a finer spectral resolution and/or an increase in the simultaneous spectral channels is possible. In the case of a cascade-type design, intermediate images are advantageously to be inserted into the imaging beam path 7 by means of relay lenses.

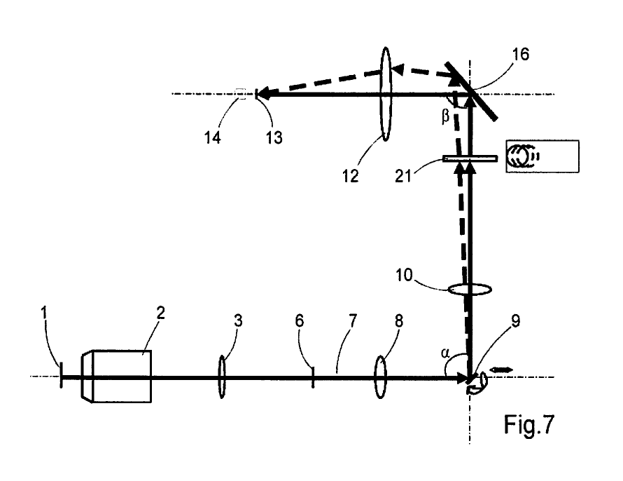

FIG. 7 shows another particularly advantageous design variant of the invention with which any desired spectral resolution can be achieved in principle.

Therefore, a filter arrangement in the form of a spectrally graduated filter 21 is positioned in an optical pupil and/or in a Fourier plane of the imaging beam path 7. The gradient or graduated filter 21 is characterized in that the spectral transmission properties change continuously or in very small increments in at least one lateral direction.

In operation of this design variant, the imaging beam path 7 is guided in increments or continuously via the graduated filter 21 with the help of the first scanning mirror 9. The descanning deflection according to one of the procedures described above ensures that the final image 13 will always be formed at the same location, regardless of the position of the imaging beam path 7.

Because of the positioning of the graduated filter 21 and the pupil and/or in the Fourier plane, no running of the color is obtained in the final image 13 but instead there is a uniform color distribution over the entire image field, so that the current spectral range corresponds to the current position of the imaging beam path 7 on the graduated filter 21. The graduated filter 21 may cover the visible spectral range and/or the UV and/or infrared spectral range. For varying the spectral resolution, either the scanning increment for the imaging beam path 7 is varied by means of the graduated filter 21 or the beam diameter is varied on the graduated filter 21 by using a zoom lens.

For example, if the imaging beam path 7 is scanned in 500 increments by means of the graduated filter 21 and if a digital image with a resolution of 1 megapixel, for example, is recorded in each step in the plane of the final image 13, this yields 500 digital images which overlap greatly spectrally but are nevertheless spectrally different and have full lateral image resolution. By spectral separation with the help of a computer unit, approximately 500 spectral cannels with full image resolution can be generated.

Assuming that each step takes 2 ms, which requires a camera with an image rate of 500 images per second, then this yields a stack of images each second containing image information with high resolution both laterally and spectrally. If the lateral image resolution is reduced to 10,000 pixels, for example, then 100 images per second can be generated at the same high spectral resolution with a lower image resolution accordingly.

In this way, the present invention can also be used for layer thickness measurements in sputtering and vapor deposition systems, for example, for glass coating, wafer coating or OLED production.

In contrast with the state of the art, measurements of layer thicknesses with a high spatial and spectral resolution using one and the same device are now possible for the first time, although in the past this could be done only by using separate measurement devices.

In addition, using the design variant according to FIG. 7, spectral measurements having spatial resolution are not possible in conjunction with chemometrics, such that the graduated filter 21 is then preferably effective in the infrared spectral range.

In summary, it should be pointed out that the imaging system according to the present invention is suitable in particular for use with imaging equipment having wide-field image capture, i.e., for example, with wide-field microscopes, operational microscopes, fundus cameras or lenses from measurement cameras of all types. The lighting may be structure or unstructured in both direct light and in transmitted light.

The invention should preferably be set up so that a separate camera, which is normally in the intermediate image 6, is to be set up at the location of the final image 13. This arrangement may be accommodated then in a housing having two optical inputs, e.g., according to the C-mount standard: one on the input side for an imaging device and another on the output side for the separate camera.

In another design, the entire arrangement according to the invention including a permanently installed camera may be located in a housing. In this case, there is optical access to the imaging device only on the input side.

In another design, the arrangement according to the present invention is part of the imaging device, so it is located in the same housing as the latter.

The arrangement according to the present invention may, however, also be used for imaging devices with scanning image capture, e.g., laser scanning microscopes or spinning disk microscopes. Laser scanning microscopes often have a so-called descanning operation in which the radiation returning from the sample is sent back by way of the laser scanning mirror. This yields a standing laser point and/or a standing laser line in the detection plane which is confocal with the object plane and corresponds to the intermediate image 6. If the arrangement according to the present invention is part of a laser scanning microscope or a laser scanning detection device in general, the detector 14 need not necessarily be a camera having two-dimensional spatial resolution, but instead may also be embodied as a line detector or as a simple intensity detector (PMT or photodiode).

This has the advantage that only a smaller light conductance need be transmitted, so that the components of the arrangement according to the present invention, in particular scanning mirrors 9 and 19, the individual filter areas of the filter mask 11 and the lenses 8, 10, 12, 15 and/or 20 may be designed to be smaller.

In fluorescence or phosphorescence imaging, the individual filters of the filter mask 11 are tuned to the excitation radiation, i.e., the excitation radiation of the light source 4 is blocked as thoroughly as possible, whereas the emission radiation is largely transmitted as much as possible by the individual filter areas of the filter mask 11. Multiband detection is also possible here, such that several separate excitation bands as well as several separate emission bands are present simultaneously.

The invention may be used to particular advantage in combination with a flexible multispectral LED fluorescence excitation source such as that described in WO 2007054301 A1.

In addition, the invention is also especially suitable for increasing the spectral resolution by means of the methods of spectral unmixing and/or improving the quantification of the intensities in the individual spectral channels.

1. An optical imaging system for multispectral imaging comprising:
a plurality of optical modules for creating an imaging beam path from polychromatic light coming from an object to be imaged;
a filter arrangement for sequential or simultaneous selection of certain spectral ranges provided for imaging the object from the imaging beam path, the filter arrangement having a plurality of individual filter areas arranged laterally side-by-side relative to a direction of propagation of the imaging beam path, the individual filter areas being designed for selection of different spectral ranges;
a deflection device through which the imaging beam path is directed at the individual filter areas;
at least one detection device for the light of the selected spectral ranges; and
an image playback and/or image evaluation device connected to the detection Device.

2. The optical imaging system according to claim 1, wherein the filter arrangement is a filter mask having individual filter areas with different spectral transmission properties or reflection properties, said filter areas being in the form of a matrix, a honeycomb, or strips, and being spectrally separate or running one into the other spectrally.

3. The optical imaging system according to claim 1, wherein the deflecting device is a scanning mirror and is coupled to a control circuit for specifying deflection angles in which the imaging beam path is directed at the individual filters predetermined for selection of spectral ranges.

4. The optical imaging system according to claim 1, further comprising a plurality of filter masks interchangeable in the imaging beam path, each filter mask associated with one of the individual filters and each having optical properties that differ with respect to the associated individual filter.

5. The optical imaging system according to claim 1, wherein the individual filters are designed to be both transmitting and reflecting, and wherein a first detection device is provided for the transmitted radiation and a second detection device is provided for the reflected radiation.

6. The optical imaging system according to any one of claim 1, wherein a facetted mirror, a DOE or a second deflecting device for compensation of the deflection caused by the deflection device is arranged downstream from the filter arrangement.

7. The optical imaging system according to claim 1, wherein the filter arrangement is a spectral graduated filter with individual filter areas running spectrally into one another.

8. The optical imaging system according to claim 1, wherein an increase in spectral resolution is achieved by spectral unmixing of measured colored channels.

9. The optical imaging system according to claim 1, wherein the detection device is a camera with spatial resolution.

10. The optical imaging system according to claim 1, wherein the detection device is a single sensor.

11. The optical imaging system according to claim 1, wherein the system has a modular design such that a conventional camera is replaceable by a multispectral measurement arrangement.

12. The optical imaging system of claim 3, wherein the scanning mirror is a MEMS scanner.
